(19) United States
(12) Patent Application Publication
(10) Pub. No.: US 2011/0225895 A1
(43) Pub. Date: Sep. 22, 2011

(54) FENESTRATION LIFT AND METHOD

(75) Inventor: Rick Peterson, Nemo, SD (US)

(73) Assignee: POWER LIFT DOOR CONSULTANTS, INC., Lake Benton, MN (US)

(21) Appl. No.: 13/051,067

(22) Filed: Mar. 18, 2011

Related U.S. Application Data
(60) Provisional application No. 61/315,698, filed on Mar. 19, 2010.

(51) Int. Cl. E06B 7/28; B65D 88/00

(52) U.S. Cl. 49/506; 220/1.5

(57) ABSTRACT

A fenestration unit as provided includes a door hinged to a frame by a hinge assembly, where the frame is secured to a structure such as a machine shed or other building. The door includes a plurality of door members connected by a plurality of door connectors, a plurality of door brackets each secured to one of the door members and connecting to a plurality of cross-members, and a weather sealing system. The door and the frame are each optionally shipped together in an unassembled state from a manufacturing and/or shipping location and are thereafter assembled at an installation site, which helps to provide a more compact and less expensive shipping package.

### CROSS REFERENCE TO RELATED APPLICATIONS

This application claims priority to U.S. Provisional Application No. 61/315,698, filed Mar. 19, 2010 and entitled, “FENESTRATION LIFT AND METHOD,” the entire contents of which are incorporated herein by reference.

### SUMMARY

Various embodiments relate to a fenestration unit and assembly method, the fenestration unit including a door hinged to a frame by a hinge assembly, where the frame is secured to a structure such as a machine shed or other building. As subsequently described, the door and the frame are each optionally shipped together in an unassembled state from a manufacturing and/or shipping location and are thereafter assembled at an installation site, which helps to provide a more compact and less expensive shipping package.

Some embodiments facilitate a seamless door seal and offer a combination of materials that not only enhance assembly options, but also to deliver better insulative performance. Additionally, some embodiments employ a fork-and-blade hinge that operates on a self lubricating pivot for reliable operation.

In some embodiments, a shipping package enclosing assembly components supplied separately from a plurality of cross-members is provided, where the plurality of cross-members are used in conjunction with the assembly components to construct a fenestration unit. The shipping package comprises a door header; a first stile, a second stile, and a third stile; a bottom rail; a plurality of door connectors each configured to connect the door header and the bottom rail to the first, second and third stiles; a plurality of door brackets configured to connect the first, second, and third stiles to a plurality of cross-members; a hinge assembly; a weather sealing system including a lower weather stripping, an upper gasket, and first and second edge gaskets; a packaging system; and instructions for assembling the components of the shipping package with the plurality of cross-members.

In some embodiments, a method of assembly of a fenestration unit is provided. The method comprises receiving assembly components in a shipping package; providing a plurality of cross-members separately from the received shipping package; and assembling the fenestration unit using the assembly components and the plurality of cross-members. The assembly components in the shipping package include a door header, a first stile, a second stile, a third stile, a bottom rail, a plurality of door connectors, a plurality of door brackets, a hinge assembly, a weather sealing system, and packaging material, the assembly components being maintained in the packaging material such that the shipping package has a volume or weight that is less than the fenestration unit once assembled.

In some embodiments, a method for providing an unassembled fenestration unit to an installer is provided. The method comprises providing door members enclosed in packaging material, the door members including a door header, a first stile, a second stile, a third stile, a bottom rail, a plurality of door connectors, a plurality of door brackets, a hinge assembly, and a weather sealing system; and providing instructions for assembling the fenestration unit using the packaged door members and a plurality of cross-members not provided in the packaging material.

While various exemplary features and advantages have been referenced above, various additional or alternative features and advantages will be understood with reference to the drawings and the description that follows. For example, while multiple embodiments are disclosed, still other embodiments of the present invention will become apparent to those skilled in the art from the following detailed description, which shows and describes illustrative embodiments of the invention. Accordingly, the drawings and detailed description are to be regarded as illustrative in nature and not restrictive.

### BRIEF DESCRIPTION OF THE DRAWINGS

FIG. 1 shows a fenestration unit secured in an opening in a structure with a door in a partially open state, according to some embodiments.

FIG. 2A shows a prior art door assembly and shipping package.

FIG. 2B shows a door assembly of the fenestration unit of FIG. 1 and a door assembly shipping package, according to some embodiments.

FIG. 3 is an exploded view of frame and door components of the fenestration unit of FIG. 1, according to some embodiments.

FIG. 4 is a side view of the fenestration unit of FIG. 1 taken in partial cross-section toward the top of the opening in the structure with the door in a closed state, according to some embodiments.

FIG. 5 is an interior view of an upper corner of the fenestration unit of FIG. 1 with the door in the closed state, according to some embodiments.

FIG. 6 is top view of the fenestration unit of FIG. 1 taken at a mid-height cross-section toward one side of the opening in the structure with the door in a closed state, according to some embodiments.

FIG. 7 is a top view of the fenestration unit of FIG. 1 toward one side of the opening in the structure with the door in a closed state, according to some embodiments.

### DETAILED DESCRIPTION

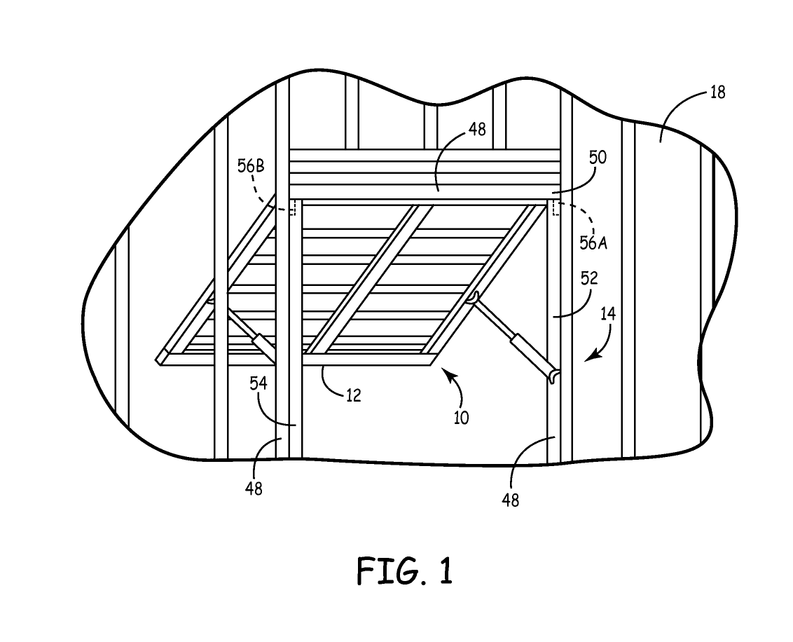

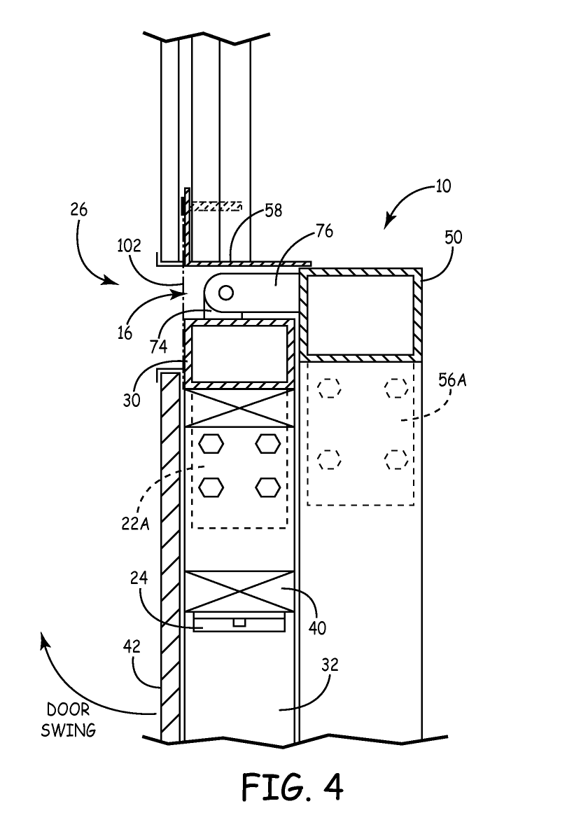

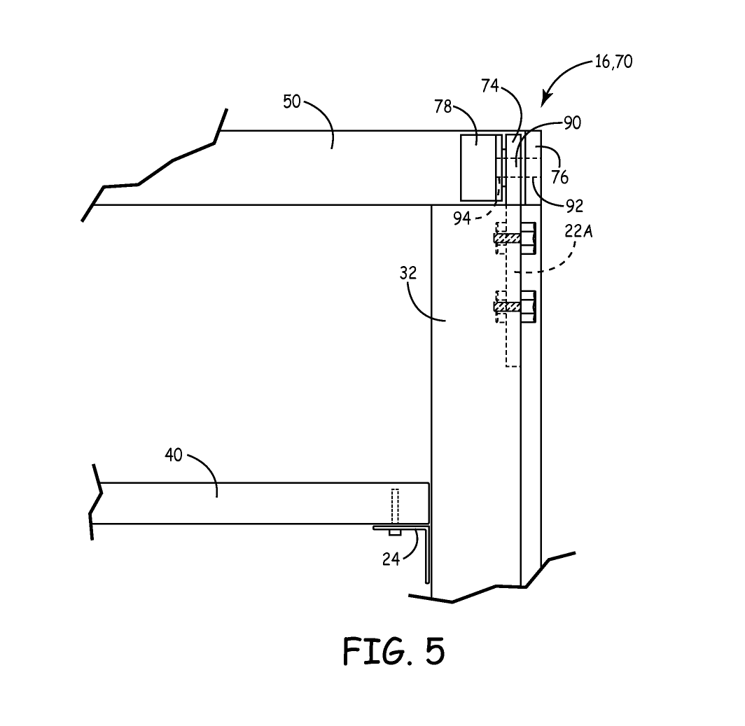

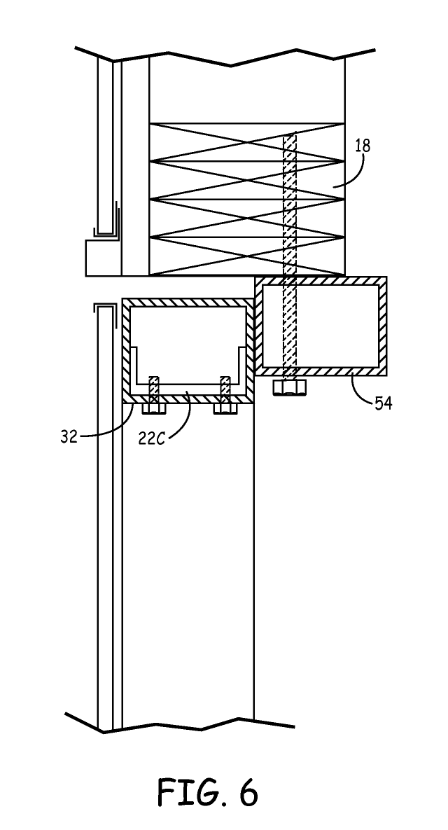

FIGS. 1 and 2B-7 show various components and features of a fenestration unit 10, the fenestration unit 10 including a door 12 hinged to a frame 14 by a hinge assembly 16 (FIG. 4), where the frame 14 is secured to a structure 18 such as a machine shed, barn, airplane hanger, or other structure.

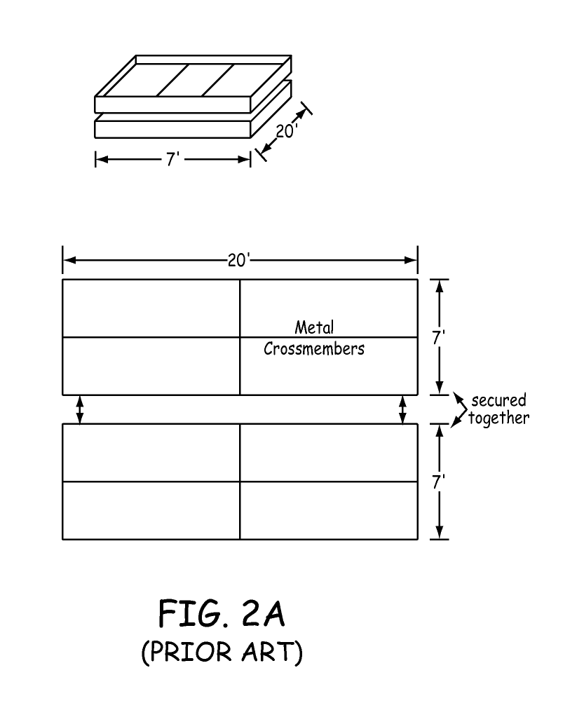

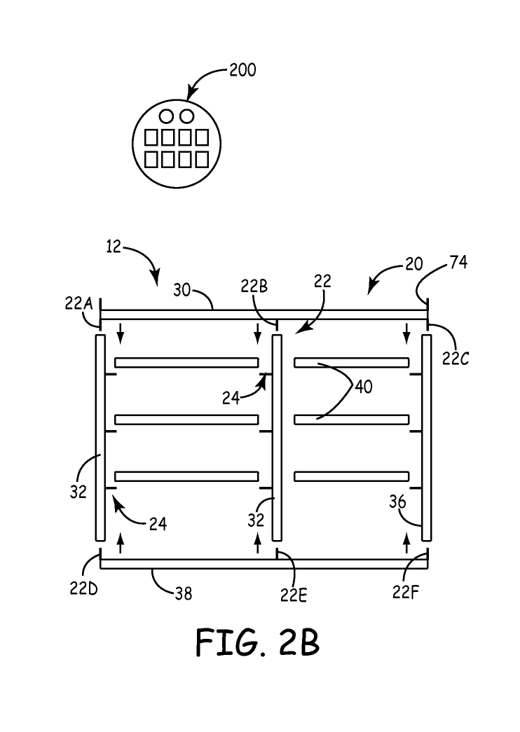

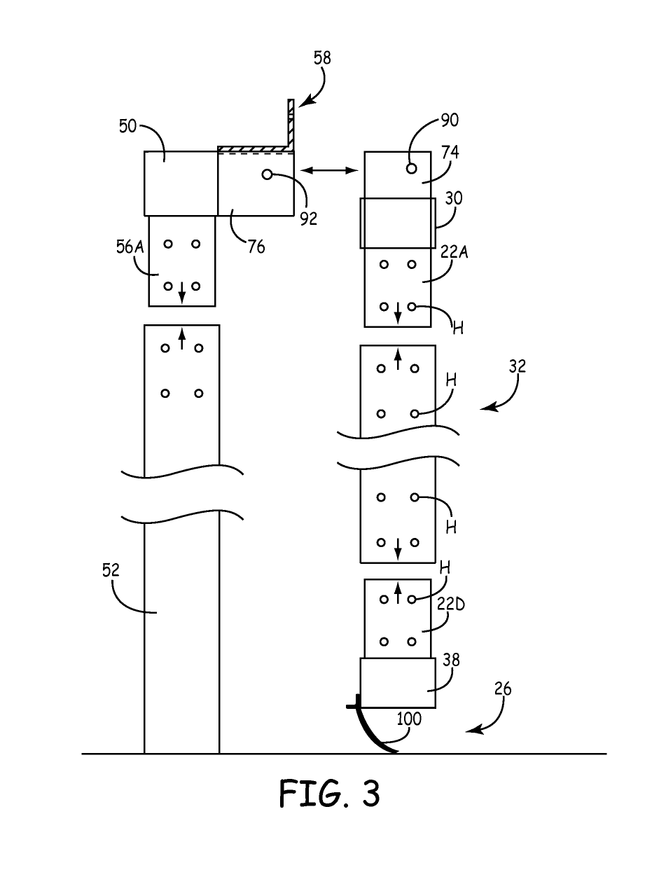

As shown in FIG. 2B, in some embodiments, the door 12 includes a plurality of door members 20, a plurality of door connectors 22 each secured to one of the door members 20, a plurality of door brackets 24 each secured to one of the door members 20, and a weather sealing system 26 (FIGS. 3 and 4).

The door members 20 include a door header 30 (also described as a top rail), a first leg 32 (also described as a first stile), a second leg 36 (also described as a second stile), a third leg 34 (also described as a center stile, muntin, or intermediate leg), a bottom rail 38, and a plurality of cross-members 40 (also described as secondary rails). In some embodiments, the door header 30, the bottom rail 38, and each of the first, intermediate, and second legs 32, 34, 36 are formed of tube stock material (e.g., 3.5 inch by 2.5 inch rectangular, mild steel, tubular stock material). In some embodiments, the door header 30, the bottom rail 38, and each of the first, intermediate, and second legs 32, 34, 36 are formed of aluminum. In turn, each of the plurality of cross-members 40 is optionally formed of wooden material (e.g., pressure treated 2×4 material) or other suitable material (e.g., mild steel or aluminum). The legs 32, 34, 36 include a pattern of bolt holes H (FIG. 3) corresponding to door connector holes H (FIG. 3) according to some embodiments.

The lengths of the door members 20 are dependent on the dimensions of the finished door. For example, in some embodiments, where the assembled door is from about 7 feet to about 14 feet in height and from about 8 feet to about 20 feet in width, the length of the each of the stiles is from about 7 feet to about 14 feet, and the length of each of the door header and the bottom rail is from about 8 feet to about 20 feet. The length of each door member 20 is adjusted as appropriate to accommodate the dimensions of the door opening and/or the dimensions of other door members 20. For example, the length of a stile may be adjusted to accommodate the width of the door header 30, the width of the bottom rail 38, and/or the height of the door opening. Similarly, the length of a cross-member 40 may be adjusted to accommodate the width of one or more of the stiles 32, 34, 36 and/or the width of the door opening.

The plurality of door connectors 22 (also described as mounting channels) include first, second, and third top connectors 22A, 22B, 22C, respectively, and first, second, and third bottom connectors 22D, 22E, 22F, respectively. Each of the door connectors 22 is optionally formed of channel material (e.g., 3 inch wide, 8 inch long, and 1.25 inch deep, mild steel, channel stock material). Each of the connectors 22 includes a plurality of holes H for receiving fasteners, such as bolts. In some embodiments, each of the holes has a corresponding a nut welded to one side of the particular connector 22 to aid in receiving a bolt.

The plurality of door brackets 24 are each optionally angle brackets (e.g., L-brackets that include two, substantially orthogonal 1.5 inch long and 3 inch wide legs).

As shown in FIG. 2B, in some embodiments, the first top connector 22A is secured at a first end of the door header 30, the second top connector 22B is secured at an intermediate position along the door header 30, and the third top connector 22C is secured at a second end of the door header 30. In some embodiments, the connectors 22A, 22B, 22C each extend substantially orthogonally from the door header 30 and substantially parallel to one another. The first bottom connector 22D is secured at a first end of the bottom rail 38, the second bottom connector 22E is secured at an intermediate position along the bottom rail 38, and the third bottom connector 22F is secured at a second end of the bottom rail 38. In some embodiments, the connectors 22D, 22E, 22F each extend substantially orthogonally from the bottom rail 38 and substantially parallel to one another. The connectors 22A, 22B, 22C, 22D, 22E, 22F are optionally secured to the door header 30 and the bottom rail 38, respectively, by welding (e.g., prior to shipping the door header 30 and the bottom rail 38). In other embodiments, the connectors 22A, 22B, 22C, 22D, 22D, 22F are secured to the door header 30 and the bottom rail, respectively, using other fastening means such as bolts.

The plurality of door brackets 24 are secured to each of the first, second, and third legs 32, 34, 36. As shown, the first leg 32 has three of the door brackets 24 attached at a top of the first leg 32, at an intermediate position on the first leg 32, and at a bottom of the first leg 32. The intermediate leg 34 has door brackets 24 attached at similar locations as does the second leg 36. The door brackets 24 are optionally welded to the legs 32, 34, 36 (e.g., prior to shipping the legs 32, 34, 36) or are secured thereto with other fastening means, such as bolts. In some embodiments, the door brackets 24 are constructed of pre-manufactured angled mild steel cut to approximately 3 inch lengths. If desired, the brackets 24 are welded on one vertical leg of the angles to the vertical/inside the door leg at approximately 30 inch intervals, for example, to produce a flat surface substantially perpendicular to the door leg. The cross-members is able to be placed on the flat surfaces. In some embodiments, the surface of the door brackets located below the wood framing will contain two holes to allow fasteners to be inserted and screwed into the cross-members 40.

As shown in FIG. 1, the frame 14 includes a plurality of frame members 48, such as a frame header 50, a first post 52, and a second post 54, a plurality of frame connectors 56, and a structural connector 58. In some embodiments, the frame header 50, the first post 52, and the second post 54 are formed of tube stock material (e.g., 3.5 inch by 2.5 inch rectangular, mild steel, tubular stock material). The posts 52, 54 optionally include a pattern of bolt holes corresponding to holes in the frame connectors 56 according to some embodiments. The frame connectors 56 (also described as mounting channels) include first and second top connectors 56A, 56B, respectively. Each of the frame connectors 56 is optionally formed of channel material (e.g., 3 inch wide, 8 inch long, and 1.25 inch deep, mild steel, channel stock material). As referenced above, each of the connectors 56 includes a plurality of holes for receiving fasteners, such as bolts.

In some embodiments, the first top connector 56A is secured at a first end of the frame header 50 and the second top connector 56B is secured at a second end of the door header 50. In some embodiments, the connectors 56A, 56B each extend substantially orthogonally from the frame header 50 and substantially parallel to one another. The connectors 56A, 56B are optionally secured to the frame header 50 by welding (e.g., prior to shipping the frame header 50). In other embodiments, the connectors 56 are secured to the frame header 50 using other fastening means such as bolts.

As shown in FIG. 3, the upper connector 58 is optionally a piece of angle stock (e.g., 3 inch, mild steel, angle stock material). The upper connector 58 is optionally welded to the frame header 50 and includes a plurality of holes for securing the upper connector 58, and thus the frame header 50, to the structure 18. Lag screws/bolts or other fasteners are optionally employed through the holes to secure the upper connector 58 to the frame header 50.

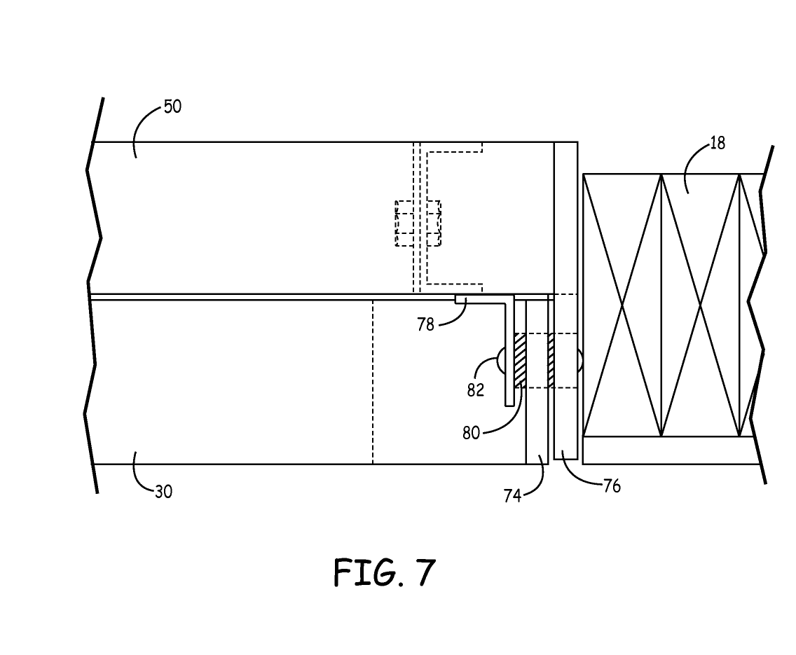

As shown in FIGS. 3-5 and 7, the hinge assembly 16 includes a first hinge 70 and a second hinge (not shown), where the first hinge 70 is secured between the frame 14 and the door 12 at the top of the door 12 toward the first side of the door 12 and the second hinge is similarly secured between the frame 14 and the door 12 toward the second side of the door 12. A third or additional hinges (not shown) are employed as desired for further support. According to some embodiments, the hinges are substantially similar and are thus described cumulatively with respect to the first hinge 70, where the first hinge 70 includes a blade 74, a plate 76, an end plate 78, a bushing 80 (FIG. 7), and a rod 82 (FIG. 7).

In some embodiments, the blade 74 is a substantially flat extension, or otherwise defines a portion to interface with the plate 76, that is secured to and extends substantially orthogonally from the first end of the door header 30. The blade 74 has a pivot hole 90 and extends in an opposite direction from the door header 30 as the door connector 22A. In some embodiments, the door connector 22A and the blade 74 are formed together as a single piece. According to some embodiments, the blade 74 is formed of mild steel, plate stock material and is secured to the door header 30 via welding or using other fastening means, such as bolts (e.g., prior to shipping the door header 30). From this, it should be apparent that a second blade (not shown) corresponding to the second hinge is similarly secured to the second end of the door header 30.

In some embodiments, the plate 76 is a substantially flat extension, or otherwise defines a portion to interface with the blade 74, that is secured to and extends substantially orthogonally from the first end of the frame header 50. The plate 76 has a pivot hole 92 and extends in a substantially orthogonal direction from the door header relative to the first frame connector 56A. In some embodiments, the frame connector 56A and the plate 76 are formed together as a single piece. According to some embodiments, the plate 76 is formed of mild steel, plate stock material and is secured to the frame header 50 via welding or using other fastening means, such as bolts (e.g., prior to shipping the frame header 50). As noted above, it should be apparent that a second plate (not shown) corresponding to the second hinge is similar secured to the second end of the frame header 50.

The end plate 78 is optionally formed as an L-shaped bracket secured to the frame header 50 adjacent plate 76. The end plate 78 includes a pivot hole 94, which upon securing the end plate 78 to the frame header 50, is coaxially aligned with the pivot hole 92 in the plate 76. The end plate 78 has a leg that extends substantially parallel to the plate 76, where the end plate leg and the plate 76 define a gap for receiving the blade 74 therebetween in a fork-and-blade arrangement. According to some embodiments, the end plate 78 is formed of mild steel, angle bracket stock material and is secured to the frame header 50 via welding or using other fastening means, such as bolts (e.g., prior to shipping the frame header 50). As noted above, it should be apparent that a second end plate (not shown) corresponding to the second hinge is similarly secured to the second end of the frame header 50.

The bushing 80 is optionally a self-lubricating bushing adapted to be received in the pivot holes 90, 92, 94 and to facilitate hinging movement of the door 12 relative to the frame 14. The rod 82 is adapted to be received through the pivot holes 90, 92, 94, as well as the bushing 80, according to some embodiments, and serves to provide a pivot about which the door 12 is able to rotate relative to the frame 14. A second bushing and bolt (not shown) are also provided for the second hinge as desired.

According to some embodiments, the weather sealing system 26 includes lower weather stripping 100 (FIG. 3), an upper gasket 102 (FIG. 4), and edge gaskets (not shown) as desired. The lower weather stripping 100 is optionally sweep seal material and includes features (barbs, adhesive, screw apertures, and/or others) for securing the lower weather stripping 100 to the bottom rail 38 of the door 12. The upper gasket 102 is optionally an elongate, rectangular sheet of gasket material (e.g., butyl rubber) that is adapted to be secured to the surface of the structure 18 (e.g., under siding on the structure 18) and to upper portion of the door 12. The upper gasket 102 is sufficiently flexible and elastic to allow repeated flexing without serious, short term degradation with door movement. The edge gaskets are secured to the door 12 and/or frame 14 as desired to assist with reducing water ingress past the fenestration unit 10.

In some embodiments, the door members 20 and the frame members 48 are each shipped in an unassembled state (with the appropriate connectors and brackets being pre-attached as previously noted) from a manufacturing and/or shipping location and are then assembled at an installation site.

FIG. 2A shows a prior art fenestration unit and associated shipping package, where the door is formed into two halves and shipped as such, with the two halves being subsequently assembled at the installation site (the frame members for the prior art fenestration unit may also be supplied in the associated shipping package). As indicated, this practice can result in shipping packages that are over 7 feet wide by 20 feet long. Such large shipping packages are expensive and difficult to ship, store, and manipulate during installation.

FIG. 2B shows the unassembled door 12 of the fenestration unit 10 and an associated shipping package 200. As shown, the elongate components (e.g., the door header 30, the stiles 32, 34, 36, and the bottom rail 38) of the door 12 and/or the frame 14 are optionally provided in the shipping package 200 as a relatively compact bundle. In some embodiments, the elongate components of the door 12 and/or the frame 14 are oriented in a generally parallel orientation within the shipping package 200.

Moreover, by utilizing readily available, wooden studs for the plurality of cross-members 40, for example, an installer or other receiver of the unit 10 may separately acquire the cross-members 40, for example from a local lumber supplier. The shipping package 200 can be thereby further reduced in size/weight as those components (e.g., cross-members 40, bolts, or covering 42) need not be shipped by the fenestration unit 10 provider in the shipping package 200. In some embodiments, the shipping package has a volume and/or weight that is less than the assembled fenestration unit. In some embodiments, an assembled fenestration unit 10 having a height of about 14 feet and a width of about 20 feet is enclosed in a shipping package 200 that has a volume of between about 35 and about 50 cubic feet. In some embodiments, the shipping package 200 is approximately 18 inches in diameter and about 20 feet long.

In some embodiments, assembly of the fenestration unit 10 and installation into the structure 18 proceeds as follows. The first and second posts 52, 54 are slipped onto the first and second top connectors 56A, 56B (the connectors 56 having been previously secured to the frame header 50) and the posts 52, 54, and connectors 56A, 56B are bolted together using the holes in the posts 52, 54 and the connectors 56A, 56B.

Having been previously secured to the frame header 50, the upper connector 58 is secured (e.g., bolted) to a truss of the structure 18 above the opening into which the fenestration unit is being installed so that the frame 14 stands in the opening in the structure 18. The posts 52, 54 are optionally bolted or otherwise secured to vertical framing members of the structure 18 to provide additional structural support to the unit 10.

The upper gasket 102 is secured to the upper connector 58 or directly to a portion of the structure 18 (e.g., under siding covering the structure 18).

The door 12 is assembled by inserting the first top connector 22A (the door connectors 22 having been first secured to the door header 30) into the first leg 32, the second top connector 22B into the intermediate leg 34, and the third top connector 22C into the second leg 36. The connectors 22A, 22B, 22C are then bolted to the legs using the bolt holes previously described to secure the door header 30 to the legs 32, 34, 36. In turn the connectors 22D, 22E, 22F are inserted into the legs 32, 34, 36, respectively. The door connectors 22D, 22E, 22F are then bolted to the legs 32, 34, 36 in order to secure the bottom rail 38 to the legs 32, 34, 36. The cross-members 40 are positioned between the legs 32 and 34 and between the legs 34 and 36 and are aligned to corresponding door brackets 24, for example being secured thereto with wood screws. The frame work formed by the door members 20 is optionally covered with a covering 42 such as pressure treated plywood, siding, water-proof sheathing material and/or other materials which, according to some embodiments, can be conveniently fastened to the cross-members 40 with wood screws.

The door 12 is hinged to the frame 14 by inserting the door blade 74 between the frame plate 76 and frame end plate 78 and inserting the bushing 80 in the pivot hole 90 and the rod 82 through the bushing 80 and pivot holes 92, 94. The second hinge (not shown) is similarly assembled. In some embodiments, the hinges operate as fork-and-blade assemblies. The materials for the frame plate 76, frame end plate 78, and door blade 74 are optionally mild steel and the bushing 80 is a resilient, low friction material. The outside of the fork portion is provided by the plate 76 which is secured (e.g., welded) on the edge on the door header 30 and the end plate 78 which is secured at a gap from and adjacent to the plate 76. The pivot holes 90, 94 are drilled slightly off center in the plate 76 and end plate 78. The blade hole 90 is equivalent in diameter to the outer diameter of the bushing 80. In some embodiments, the connector 22A and the blade 74 are a single piece, where the door leg 32 is bolted to the same plate constituting the blade 74. In some embodiments, the blade 74 operates on the self-lubricating bushing 80, where the bushing is restrained between the plate 76 and end plate 78 and the rod 82 is inserted through and welded to the plate 76 and end plate 78.

The upper gasket 102 is secured over the door header 30 to seal the gap between the door header 20 and the upper edge of the opening in the structure 18. The edge seals and/or lower weather stripping 100 are secured to the door 12 and/or adjusted as desired to provide a weather seal when the door 12 is in a closed state. Door accessories such as hydraulic pumps and associated components are attached as desired to open and close the door 12.

In some embodiments, upon closing, the seal of the door 12 is improved by providing continuous legs and posts without any splice in the door legs. By doing so, a single length, continuous door leg that seals against a single length frame post, the two being pulled and held tight together by hydraulic force. The single length posts and legs eliminate seal inconsistency caused by splicing members. As previously referenced gasketing materials are optionally secured to the posts/legs to further enhance sealing.

Various modifications and additions can be made to the exemplary embodiments discussed without departing from the scope of the present invention. For example, while the embodiments described above refer to particular features, the scope of this invention also includes embodiments having different combinations of features and embodiments that do not include all of the above described features.

The following examples are not intended to be limiting in nature, but is instead illustrative of various features, components, and advantages of the present invention.

What is claimed is:

1. A shipping package enclosing assembly components supplied separately from a plurality of cross-members, the plurality of cross-members being used in conjunction with the assembly components to construct a fenestration unit, and the shipping package comprising:
a door header;
a first stile, a second stile, and a third stile;
a bottom rail;
a plurality of door connectors each configured to connect the door header and the bottom rail to the first, second and third stiles;
a plurality of door brackets configured to connect the first, second, and third stiles to a plurality of cross-members;
a hinge assembly;
a weather sealing system including a lower weather stripping, an upper gasket, and first and second edge gaskets;
a packaging system; and
instructions for assembling the components of the shipping package with the plurality of cross-members.

2. The shipping package of claim 1, wherein the packaging system maintains the door header, the first, second, and third stiles, and the bottom rail in a generally parallel orientation.

3. The shipping package of claim 1, wherein the fenestration unit, when assembled, has a width of about 20 feet and a height of about 14 feet, and the shipping package has a volume of between about 35 and about 50 cubic feet.

4. The shipping package of claim 3, wherein the shipping package has a diameter of about 18 inches.

5. The shipping package of claim 1, wherein the hinge assembly includes a blade, a plate, an end plate, a bushing, and a rod.

6. The shipping package of claim 5, wherein the blade is connected to a door connector.

7. A method of assembly of a fenestration unit, the method comprising:
receiving assembly components in a shipping package, the assembly components including a door header, a first stile, a second stile, a third stile, a bottom rail, a plurality of door connectors, a plurality of door brackets, a hinge assembly, a weather sealing system, and packaging material, the assembly components being maintained in the packaging material such that the shipping package has a volume or weight that is less than the fenestration unit once assembled;
providing a plurality of cross-members separately from the received packaging system; and
assembling the fenestration unit using the assembly components and the plurality of cross-members.

8. The method of claim 7, further comprising receiving the assembly components in the shipping package with the door header, the stiles, and the bottom rail oriented in the packaging material in a generally parallel orientation.

9. The method of claim 7, further comprising receiving the shipping package with a volume of between about 35 and about 50 cubic feet and assembling the fenestration unit with a width of about 20 feet and a height of about 14 feet.

10. The method of claim 9, wherein the shipping package is received with a diameter of about 18 inches.

11. The method of claim 7, wherein the hinge assembly includes a blade, a plate, an end plate, a bushing, and a rod.

12. The method of claim 11, wherein the blade is a substantially flat extension of a door connector.

13. The method of claim 7, further comprising assembling a covering supplied separately from the shipping package to the plurality of cross-members.

14. A method for providing an unassembled fenestration unit to an installer, the method comprising:
providing door members enclosed in packaging material, the door members including a door header, a first stile, a second stile, a third stile, a bottom rail, a plurality of door connectors, a plurality of door brackets, a hinge assembly, and a weather sealing system; and
providing instructions for assembling the fenestration unit using the packaged door members and a plurality of cross-members not provided in the packaging material.

15. The method of claim 14, wherein the cross-members are formed of pressure treated 2×4 material.

16. The method of claim 14, wherein the instructions for assembling the fenestration unit provide for assembling a covering member not provided in the packaging material to the plurality of cross-members.
